(19) United States
(12) Patent Application Publication
(10) Pub. No.: US 2023/0203879 A1
(43) Pub. Date: Jun. 29, 2023

(54) SOLAR ELECTRIC ROLLER SHADE

(71) Applicant: Yangli DENG, Guangdong (CN)

(72) Inventors: Yangli DENG, Guangdong (CN); Weipin SONG, Guangdong (CN); Haisheng XU, Guangdong (CN)

(21) Appl. No.: 17/578,492

(22) Filed: Jan. 19, 2022

(30) Foreign Application Priority Data
Dec. 23, 2021 (CN) 202123298868.9

(51) Int. Cl. E06B 9/68; E06B 9/262

(52) U.S. Cl. CPC E06B 9/68; E06B 9/262; E06B 2009/2476

(57) ABSTRACT

The present invention relates to a solar electric roller shade, including a roller shade body and a solar panel that are independent of each other. The roller shade body includes a scroll, a curtain cloth wound onto the scroll, and a speed reduction motor for driving the scroll to rotate, the solar panel is externally disposed on a back surface of the roller shade body through a fixed support member, and the solar panel is electrically connected to the speed reduction motor and a battery. In the present invention, the solar panel and the roller shade body are two separated independent structures. Once mounted and debugged, the solar panel can continuously absorb light energy and provide electric energy for the electric roller shade under sufficient sunlight, and the solar panel is mounted on the back surface of the roller shade body without occupying a special erection space.

### BACKGROUND OF THE INVENTION

The present invention relates to the field of roller shades, and in particular, to a solar electric roller shade.

Solar curtains are new energy products that combine solar products with curtains. Electric energy can be provided to a speed reduction motor of a curtain for rotation by using solar light, to reduce the consumption of electric resources.

A solar thin film product is adopted for a solar electric curtain on the market and is disposed on a curtain cloth, but the structure has the following defects: when the curtain is in a retracted state, the solar film product cannot obtain energy, so it is impossible to realize that the sunlight enters a room and the solar thin film absorbs light energy under sufficient sunlight.

There is also a solar electric curtain on the market. A solar panel is erected on a courtyard or roof, and then is electrically connected to the electric curtain to obtain electric energy, but the structure has the following defects: sufficient installation site is required to build support frames, with high space occupation rate and site requirements.

Based on the foregoing, in existing solar electric curtains, a photovoltaic function conflicts with a retraction and releasing process of the curtain, or erection of a photovoltaic assembly requires a relatively large space. The above problems are worth resolving.

### BRIEF SUMMARY OF THE INVENTION

To overcome the defects of an electric curtain in the related art, the present invention provides a solar electric roller shade.

A technical solution of the present invention is as follows: a solar electric roller shade is provided, including a roller shade body and a solar panel that are independent of each other, where the roller shade body includes a scroll, a curtain cloth wound onto the scroll, and a speed reduction motor for driving the scroll to rotate, the solar panel is externally disposed on a back surface of the roller shade body through a fixed support member, a light receiving surface of the solar panel faces outward, and the solar panel is electrically connected to the speed reduction motor and a battery.

Optionally, the top of the roller shade body is provided with a cross beam, the battery is disposed inside the cross beam, and the speed reduction motor is disposed below the cross beam.

Optionally, the speed reduction motor is located in a cavity at an end portion of the scroll, and the speed reduction motor and the battery are located at the same side of the cross beam.

Optionally, the fixed support member includes a plurality of L-shaped angle steels, and one end of the L-shape angle steel connects the cross beam to the top of a wall and the other end is connected to the solar panel.

Optionally, one end of the L-shaped angle steel connected to the solar panel is provided with a telescopic rod, and the telescopic rod is configured to adjust a height of the solar panel.

Optionally, a short side of the L-shaped angle steel is connected to an upper surface of the cross beam, and a long side of the L-shaped angle steel is located at the back surface of the roller shade body and is detachably connected to the solar panel.

Optionally, the long side of the L-shaped angle steel is vertically downward, and the long side is provided with a plurality of mounting holes to form mounting positions of the solar panel at different heights.

Optionally, the cross beam includes a cross beam body and side cover boards connected to two ends of the cross beam body, a cavity for accommodating the battery is provided inside the cross beam body, and the bottom of the cross beam body is arched upward, so that a scroll slot is formed under the cross beam body.

Optionally, a fixed end of the speed reduction motor is connected to the side cover board, and a rotation end of the speed reduction motor is clamped with an inner wall surface of the scroll.

Optionally, the rotation end of the speed reduction motor is provided with a connecting wheel, a wheel surface of the connecting wheel is provided with a plurality of first connecting grooves, an inner wall surface of the scroll is provided with a plurality of second connecting grooves, and the first connecting grooves are engaged with the second connecting grooves.

Optionally, a cross section of the first connecting groove is in an epsilon shape, and a cross section of the second connecting groove is in a concave shape.

Optionally, a top surface of the cross beam body is provided with a step surface, and the fixed support member is connected to a lower side of the step surface, so that an upper surface of the fixed support member is flush with a top end of the cross beam body.

Optionally, one side of a front surface of the cross beam is provided a light blocking plate, and a top end of the light blocking plate is in contact with a wall at the top.

Optionally, a first connecting port matching the cross beam body is provided above an inner side surface of the side cover board, and a second connecting port matching the scroll is provided below the inner side surface of the side cover board.

Optionally, a center of the second connecting port is provided with a cross-shaped connector, one end of the speed reduction motor is provided with a cross-shaped groove, and the cross-shaped connector is engaged with the cross-shaped groove.

Optionally, a working main board of the roller shade body is mounted in the first connecting port of one of the side cover boards, and the working main board is electrically connected to the battery and the speed reduction motor.

Optionally, the working main board is connected to the speed reduction motor by a cable, and the cable passes through an inner wall of the first connecting port and extends into the scroll to be connected to the speed reduction motor.

Optionally, the working main board includes a first main board and a second main board that are disposed vertically, the first main board is parallel to the side cover board and is closely attached to an inner surface of the side cover board, and the second main board is perpendicular to the side cover board.

Optionally, a side surface of the side cover board is provided with a socket, and the socket is connected to an output line of the solar panel.

Optionally, a connector of the output line of the solar panel is a Type-C connector.

Optionally, the working main board is provided with a function control module, the function control module is connected to an antenna, a lower end of the side cover board protrudes from the cross beam body, and an inner side surface of a protruding portion is provided with a wire slot for hiding the antenna.

Optionally, the wire slot is provided at an edge of the inner side surface of the protruding portion of the side cover board.

Optionally, the roller shade body is a roman shade, and the roman shade includes a scroll with a cord winder, a ladder rope, and a curtain cloth.

The solution of the present invention has the beneficial effects as follows.

In the present invention, the solar panel and the roller shade body are two separated independent structures. The solar panel is externally disposed on the back surface of the roller shade body without being affected by a process of retracting and releasing the curtain cloth of the electric roller shade. Once mounted and debugged, the solar panel can continuously absorb light energy and provide electric energy for the electric roller shade under sufficient sunlight, and the solar panel is mounted on the back surface of the roller shade body without occupying a special erection space, which greatly reduces a space occupation rate.

### BRIEF DESCRIPTION OF THE DRAWINGS

FIG. 1 is a schematic structural diagram of the present invention.

FIG. 2 is an exploded view of the present invention.

FIG. 3 is an enlarged view of a section A in FIG. 2.

FIG. 4 is a perspective view of an internal structure of the present invention.

FIG. 5 is a local cross-sectional view of a roller shade body.

FIG. 6 is a schematic structural diagram of a side cover board.

In the drawings:
1. Roller shade body;
101. Cross beam
1011. Cross beam body; 10111. Step surface; 10112. Light blocking plate;
1012. Side cover board; 10121. First connecting port; 10122. Second connecting port; 10123. Socket;
102. Scroll; 1012. Second connecting groove;
103. Curtain cloth;
104. Speed reduction motor; 1041. First connecting groove; 1042. Cross-shaped groove;
105. Battery;
106. Working main board; 1061. First main board; 1062. Second main board; 1063. Antenna; 1064. Cable;
2. Solar panel; 201. Output line;
3. Fixed support member; 301. Short side; 302. Long side; and 303. Mounting hole.

### DETAILED DESCRIPTION OF THE INVENTION

To better understanding the objects, the technical solutions, and the technical effect of the present invention, the present invention is further described with reference to the accompanying drawings and the embodiments. At the same time, it indicates that the follow described embodiments is merely for describing the present invention, but not for limiting the present invention.

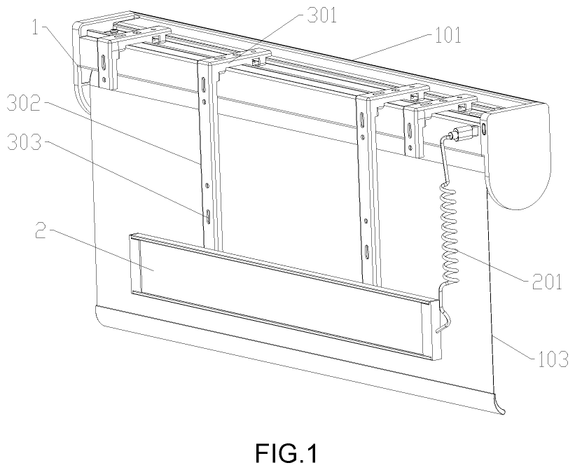

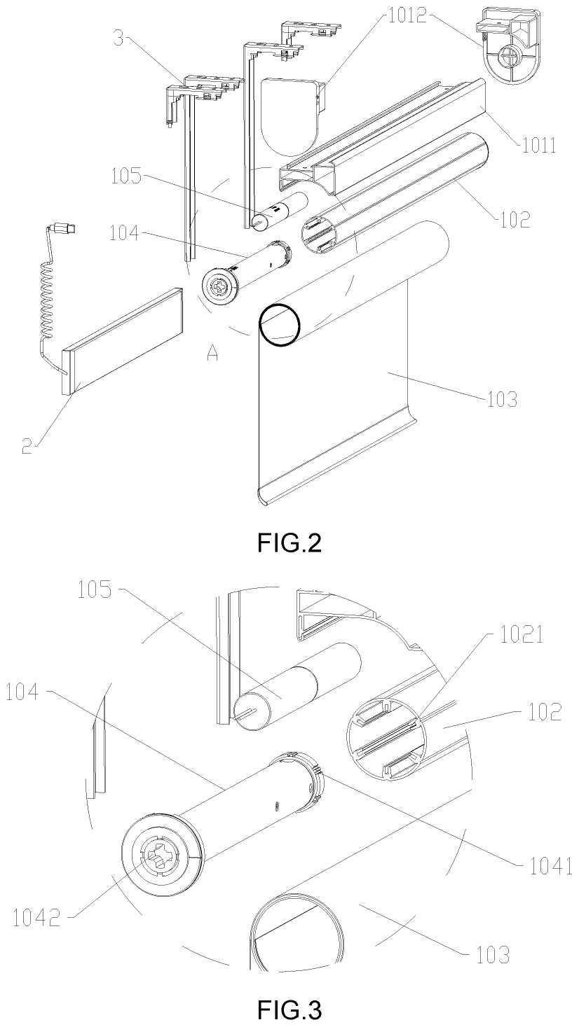

As shown in FIG. 1 and FIG. 2, a solar electric roller shade is provided, including a roller shade body 1 and a solar panel 2 that are independent of each other. The roller shade body 1 includes a scroll 102, a curtain cloth 103 wound onto the scroll 102, and a speed reduction motor 104 for driving the scroll 102 to rotate, the solar panel 2 is externally disposed on a back surface of the roller shade body 1 through a fixed support member 3, a light receiving surface of the solar panel 2 faces outward, and the solar panel 2 is electrically connected to the speed reduction motor 104 and a battery 105.

By using the technical solution, the solar panel 2 and the roller shade body 1 are two separated independent structures. The solar panel 2 is externally disposed on the back surface of the roller shade body 1 without being affected by a process of retracting and releasing the curtain cloth 103 of the electric roller shade. Once mounted and debugged, the solar panel 2 can continuously absorb light energy and provide electric energy for the electric roller shade under sufficient sunlight.

In this embodiment, the top of the roller shade body 1 is provided with a cross beam 101, the battery 105 is disposed inside the cross beam 101, and the speed reduction motor 104 is disposed below the cross beam 101. The cross beam 101 is configured to fix the electric roller shade to the top of a wall close to a window and separate the battery 105 from another element such as the speed reduction motor 104, to reduce interference and improve the stability of a power system. The battery 105 is in contact with a cross beam body 1011, which is conducive to exporting the heat generated during operation of the battery 105.

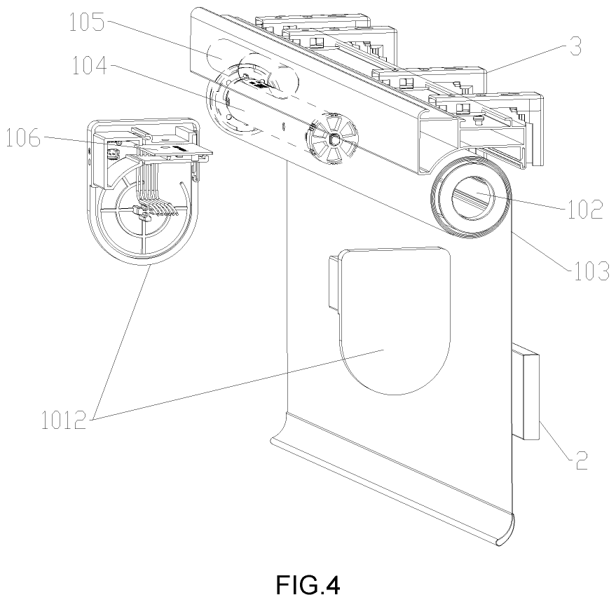

As shown in FIG. 4, in this embodiment, the speed reduction motor 104 is located in a cavity at an end portion of the scroll 102, and the speed reduction motor 104 and the battery 105 are located at the same side of the cross beam 101. The speed reduction motor 104 is located inside the scroll 102, so that a driving structure of the electric roller shade is more compact, which is conductive to reducing a size of the electric roller shade. The speed reduction motor 104 and the battery 105 are located at the same side, which is conductive to reducing a length of a connecting line and reducing unnecessary power consumption.

In this embodiment, the fixed support member 3 includes a plurality of L-shaped angle steels. One end of the L-shaped angle steel connects the cross beam 101 to the top of the wall, and the other end is connected to the solar panel 2. A short side 301 of the L-shaped angle steel is connected to an upper surface of the cross beam 101, and a long side 302 of the L-shaped angle steel is located at the back surface of the roller shade body 1 and is detachably connected to the solar panel 2. The solar panel 2 and the electric roller shade are effectively assembled by using the L-shaped angle steel with a simple structure, so that the solar panel 2 is effectively fixed and supported without using a complex solar panel 2 fixing support frame, thereby greatly reducing a space occupation rate.

In a preferred embodiment, one end of the L-shaped angle steel connected to the solar panel is provided with a telescopic rod, which is configured to adjust a height of the solar panel. When the solar panel needs to be raised, a length of the telescopic rod is reduced; and when the solar panel needs to be lowered, the length of the telescopic rod is extended, so that the height of the solar panel is adjusted more conveniently.

In an optional embodiment, the long side 302 of the L-shaped angle steel is vertically downward, and the long side 302 is provided with a plurality of mounting holes 303 to form mounting positions of the solar panel 2 at different heights. A mounting height of the solar panel 2 is optional. An appropriate mounting height of the solar panel 2 is selected according to an actual structure of the window and surroundings thereof. The eaves or other walls outside the window can be prevented from blocking the solar panel 2 and affecting the absorption of light energy, resulting in reduction of the power generation efficiency of the solar panel 2.

In an optional embodiment, the cross beam 101 includes a cross beam body 1011 and side cover boards 1012 connected to two ends of the cross beam body, a cavity for accommodating the battery 105 is provided inside the cross beam body 1011, and the bottom of the cross beam body 1011 is arched upward, so that a scroll slot is formed under the cross beam body 1011. The side cover board 1012 may be removed from the cross beam body 1011 through a connecting structure between the cross beam body 1011 and the side cover board 1012, which is convenient for maintenance and replacement of the internal speed reduction motor 104 and a working main board 106. An independent cavity for the battery 105 in the cross beam body 1011 plays both a storage role and a protection role. The scroll 102 is located at the scroll slot, so that the top structure of the electric roller shade is more impact.

A fixed end of the speed reduction motor 104 is connected to the side cover board 1012, and a rotation end of the speed reduction motor 104 is clamped with an inner wall surface of the scroll 102. The rotation end of the speed reduction motor 104 is provided with a connecting wheel, a wheel surface of the connecting wheel is provided with a plurality of first connecting grooves 1041, an inner wall surface of the scroll 102 is provided with a plurality of second connecting grooves 1021, and the first connecting grooves 1041 are engaged with the second connecting grooves 1021. A cross section of the first connecting groove 1041 is in an epsilon shape, and a cross section of second connecting groove 1021 is in a concave shape. Compared with a conventional structure in which the speed reduction motor 104 is connected to the scroll 102 in parallel, in the technical solution, in the scroll 102, the speed reduction motor 104 drives the scroll 102 to rotate through the connecting wheel with a relatively large driving force, to reduce the burden of the speed reduction motor 104, thereby saving energy consumption. In addition, a structure design between the first connecting groove 1041 and the second connecting groove 1021 improves the firmness of the connection between the two connecting grooves, to avoid slippage between the speed reduction motor 104 and the scroll 102, thereby ensuring the stability of the process of retracting and releasing the curtain cloth 103 of the electric roller shade.

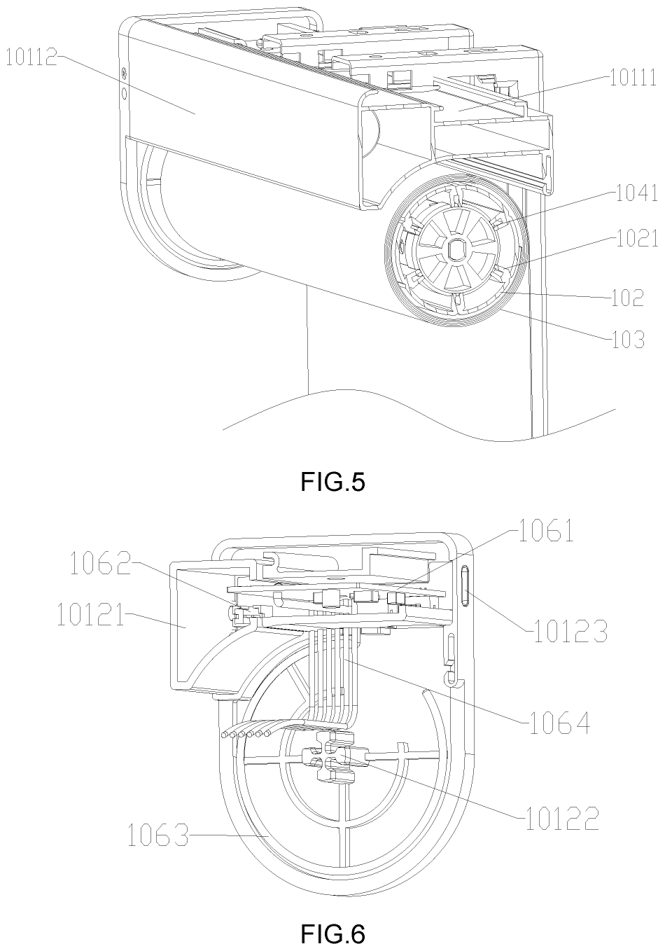

As shown in FIG. 5, in an optional embodiment, a top surface of the cross beam body 1011 is provided with a step surface 10111, and the fixed support member 3 is connected to a lower side of the step surface 10111, so that an upper surface of the fixed support member 3 is flush with a top end of the cross beam body 1011. When the electric roller shade is fixed to a ceiling through the cross beam 101, because the fixed support member 3 is disposed in a lower region of the step surface 10111, a front surface of the cross beam 101 and the side cover boards 1012 at the two sides block the fixed support member 3, to avoid protrusion of the fixed support member 3, thereby achieving a neat and beautiful shape of the electric roller shade.

In an optional embodiment, one side of a front surface of the cross beam body 1011 is provided a light blocking plate 10112, and a top end of the light blocking plate 10112 is in contact with a wall at the top. The top end of the light blocking plate 10112 can be in contact with the ceiling, to reduce light outside the window leaking into the room from a gap at the top of the electric roller shade, which affects a light shielding effect of the curtain. The light blocking plate 10112 can further prevent the dust on the cross beam 101 from falling from the front surface of the electric roller shade. Moreover, due to the shielding effect of the light blocking plate 10112, the dust on the top of the cross beam 101 cannot be seen from the front surface of the electric roller shade, which makes an appearance of the electric roller shade cleaner and provides a good use experience for customers.

As shown in FIG. 3 and FIG. 6, in an optional embodiment, a first connecting port 10121 matching the cross beam body 1011 is provided above an inner side surface of the side cover board 1012, and a second connecting port 10122 matching the scroll 102 is provided below the inner side surface of the side cover board. A center of the second connecting port 10122 is provided with a cross-shaped connector, one end of the speed reduction motor 104 is provided with a cross-shaped groove 1042, and the cross-shaped connector is engaged with the cross-shaped groove. A cross-shaped connecting structure can be effectively engaged with the scroll from up, down, left, and right directions, to prevent the scroll from shaking and keep the scroll rotating smoothly.

In an optional embodiment, a side surface of the side cover board 1012 is provided with a socket 10123, and the socket 10123 is connected to an output line 201 of the solar panel 2. A connector of the output line 201 of the solar panel 2 is a Type-C connector. The solar panel 2 is electrically connected to the electric roller shade conveniently and quickly without a need to adjust a direction of the connector, thereby improving the user experience.

In an optional embodiment, a working main board 106 of the roller shade body 1 is mounted in the first connecting port 10121 of one of the side cover boards 1012, and the working main board 106 is electrically connected to the battery 105 and the speed reduction motor 104. The working main board 106 is fixed to the side cover board 1012 through the first connecting port 10121, so that the working main board is effectively protected. The working main board 106 and the first connecting port 10121 of the side cover board 1012 share a space inside the scroll 102, a reasonable layout design is achieved, the space occupation rate is reduced, and the structure is more compact.

In an optional embodiment, the working main board 106 is connected to the speed reduction motor 104 by a cable 1064, and the cable 1064 passes through an inner wall of the first connecting port 10121 and extends into the scroll 102 to be connected to the speed reduction motor 104. It can be seen that the cable is led out from the inner wall of the first connecting port 10121, which can prevent wires from being scattered and reduce a circuit fault, and the regular wire is also convenient for maintenance.

In an optional embodiment, the working main board 106 includes a first main board 1061 and a second main board 1062 that are disposed vertically, the first main board 1061 is parallel to the side cover board 1012 and is closely attached to an inner surface of the side cover board 1012, and the second main board 1062 is perpendicular to the side cover board 1012. A unique double-board vertical structure design of the working main board 106 enables the working main board 106 to be placed in the narrow first connecting port 10121 of the side cover board 1012.

In an optional embodiment, the working main board 106 is provided with an antenna 1063 configured to receive a control signal, a lower end of the side cover board 1012 protrudes from the cross beam body 1011, and an inner side surface of a protruding portion is provided with a wire slot for accommodating the antenna 1063. The antenna 1063 is fixed into the wire slot, which is not only beautiful, but also can be effectively protected, and the antenna is prevented from hanging outside, which is easy to be cut off by the user as a messy wire.

In an optional embodiment, the wire slot is provided at an edge of the inner side surface of the protruding portion of the side cover board 1012. The antenna 1063 rotates around the second connecting port 10122 along the periphery of the protruding portion under the side cover board 1012, which does not affect the rotation of the scroll 102, but also can prevent the antenna 1063 from being blocked or hidden, so as to sensitively receive the control signal.

In another embodiment, the roller shade body is a roman shade, and the roman shade includes a scroll with a cord winder, a ladder rope, and a curtain cloth.

A working process of the present invention is that: the solar panel absorbs light energy, converts the light energy to electric energy and stores the electric energy in the battery, and provides the electric energy required by the electric roller shade for working; when a user operates a remote control, the working main board receives a signal through the antenna, and the speed reduction motor rotates forward or reverse according to an input instruction, to drive the scroll to rotate, so as to retract or release the curtain cloth; and an operation function includes a curtain raising function, a curtain lowering function and a stop function, where the stop function can be used for ordering the curtain cloth to stop at any position.

The technical features of the foregoing embodiments can be arbitrarily combined. To simplify the descriptions, all possible combinations of the technical features in the above embodiments have not been described. However, as long as there is no contradiction in the combinations of these technical features, the combinations should be considered as the scope described in this specification. It should be noted that, for those of ordinary skill in the art, without departing from the concept of the present invention, modifications and improvements can be further made, and all belong to the protection scope of the present invention. Therefore, the protection scope of the patent for the present invention shall be subject to the appended claims.

What is claimed is:

1. A solar electric roller shade, comprising a roller shade body and a solar panel that are independent of each other, wherein
the roller shade body comprises a scroll, a curtain cloth wound onto the scroll, and a speed reduction motor for driving the scroll to rotate, and
the solar panel is externally disposed on a back surface of the roller shade body through a fixed support member, a light receiving surface of the solar panel faces outward, and the solar panel is electrically connected to the speed reduction motor and a battery.

2. The solar electric roller shade according to claim 1, wherein the top of the roller shade body is provided with a cross beam, the battery is disposed inside the cross beam, and the speed reduction motor is disposed below the cross beam.

3. The solar electric roller shade according to claim 2, wherein the speed reduction motor is located in a cavity at an end portion of the scroll, and the speed reduction motor and the battery are located at the same side of the cross beam.

4. The solar electric roller shade according to claim 1, wherein the fixed support member comprises a plurality of L-shaped angle steels, and one end of the L-shape angle steel connects the cross beam to the top of a wall and the other end is connected to the solar panel.

5. The solar electric roller shade according to claim 4, wherein a short side of the L-shaped angle steel is connected to an upper surface of the cross beam, and a long side of the L-shaped angle steel is located at the back surface of the roller shade body and is detachably connected to the solar panel.

6. The solar electric roller shade according to claim 2, wherein the cross beam comprises a cross beam body and side cover boards connected to two ends of the cross beam body, a cavity for accommodating the battery is provided inside the cross beam body, and the bottom of the cross beam body is arched upward, so that a scroll slot is formed under the cross beam body.

7. The solar electric roller shade according to claim 6, wherein a first connecting port matching the cross beam body is provided above an inner side surface of the side cover board, and a second connecting port matching the scroll is provided below the inner side surface of the side cover board.

8. The solar electric roller shade according to claim 7, wherein a working main board of the roller shade body is mounted in the first connecting port of one of the side cover boards, and the working main board is electrically connected to the battery and the speed reduction motor.

9. The solar electric roller shade according to claim 8, wherein the working main board is connected to the speed reduction motor by a cable, and the cable passes through an inner wall of the first connecting port and extends into the scroll to be connected to the speed reduction motor.

10. The solar electric roller shade according to claim 8, wherein the working main board comprises a first main board and a second main board that are disposed vertically, the first main board is parallel to the side cover board and is closely attached to an inner surface of the side cover board, and the second main board is perpendicular to the side cover board.
